(19) United States
(12) Patent Application Publication
(10) Pub. No.: US 2011/0037238 A1
(43) Pub. Date: Feb. 17, 2011

(54) Skateboard Assembly

(76) Inventors: Donald Andrew Devine, Costa Mesa, CA (US); Robert J. Buake, Costa Mesa, CA (US)

Correspondence Address: Fitzpatrick Patents, 4002 River Avenue, Unit B, Newport Beach, CA, 92663, US

(21) Appl. No.: 12/542,480

(22) Filed: Aug. 17, 2009

(51) Int. Cl. B62M 1/00

(52) U.S. Cl. 280/87.042

(57) ABSTRACT

The present disclosure provides a skateboard assembly for providing a rider a surf-like experience having a deck having a bow, an aft, and a wheelbase, an aft truck and a bow truck each comprising an axle, the trucks disposed transversely beneath the deck, wherein the distance between the aft truck and the bow trick axles define a wheelbase, and
wherein the axle of the aft truck has a length greater than the axle of the bow truck.

### BACKGROUND

The present invention relates to a skateboard assembly. More particularly, the present invention relates to a skateboard that provides a rider a surf-like experience.

Skateboards have been in existence for many years. Over time, skateboards have morphed from larger surf-like boards to smaller boards having concave ends allowing the user to perform a myriad of tricks, both on a street and on a variety of ramps. Recently, as riders desire a more leisurely experience, skateboards have again become increasingly larger and lack concavity. These skateboards, sometimes referred to as longboards, are very heavy to provide momentum, and are used by riders for what is known as “cruising”.

While riders use of skateboards has changed over time, the elements of the skateboard have changed little. A skateboard generally comprises a deck beneath which two devices for holding an axle are fixed. Generally, each of the holding devices is directional, and the axle which they hold supports two wheels. Such devices for directional holding of an axle are commonly referred to as trucks.

The trucks make it possible to control the direction of the skateboard, while the skater has both feet positioned on the deck and moves with the latter by rolling. The control of the direction is carried out by shifting the skater's weight to one side or the other.

Trucks generally have a base plate that ensures the fixing of the truck beneath the deck and a hanger. One of the ends of the hanger is extended along a first laterally axis and pivots about a point located in the base plate. This end, also called the pivot, penetrates into a recess that is provided in the base plate. A second end of the hanger has a protuberance called a ring. The latter is held by means of two elastomeric pieces called buffers and a kingpin oriented along a second axis applied on the base plate. Finally, a third end of the hanger serves as a support for an axle on which two wheels are mounted, this axle being oriented along a third axis.

The orientation of the three axes of the hanger in relation to one another is such that the inclination of the deck on either of its lateral edges, i.e., along a longitudinal axis of the deck, creates a pivoting of the axle along a vertical axis. Generally speaking, the kingpin forms, together with the plane of the deck, an angle that is not a right angle.

Skateboard trucks, despite their simplicity, fulfill several functions. First, they are means for fixing the wheels to the deck which enable the skater to direct the deck. Second, the presence of the elastomeric elements produces a resistance to the forces generated by the skater to pivot the deck, and thereby prevents unexpected changes in direction. Finally, these same elastomers ensure a force for returning the axle in a neutral position after a change in direction.

The construction of skateboard decks generally include several types of materials including plastic materials, wood, and composite materials, in particular. Each of these materials has specific characteristics and advantages. Most decks are constructed with a seven to nine-ply cross-laminated layup of Canadian maple. Other materials used in deck construction, fiberglass, bamboo, resin, Kevlar, carbon fiber, aluminum, and plastic, lighten the board or increase its strength or rigidity. Some decks made from maple ply are dyed to create various different colored ply. Modern decks vary in size, but most are 7 to 10.5 inches wide, and are referred to as “regular shape”. Other known skateboard deck shapes include punk nose pool, cruiser, pintail, old school, and longboard shape.

It is known that the skateboard and surfing communities are tied very closely, as a large percentage of skateboards are surfers, and vice versa. However, due to water conditions, temperature conditions, or a rider's disposition at a current time, he or she may desire a surfing experience on land. However, known skateboards and longboards do not provide a satisfactory surfing experience, as they do not account for board size and shape (or profile).

Therefore, an improved skateboard assembly better able to emulate a surf experience is desired.

### BRIEF DESCRIPTION

The present disclosure describes a skateboard assembly that provides a rider a surf-like experience.

In an embodiment, the invention provides a skateboard assembly for providing a rider a surf-like experience, said skateboard assembly comprising a deck having a bow, an aft, and a wheelbase, an aft truck and a bow truck each comprising an axle, the trucks disposed transversely beneath the deck, wherein the distance between the aft truck and the bow trick axles define a wheelbase, and wherein the axle of the aft truck has a length greater than the axle of the bow truck.

In accordance with another embodiment of the present invention, a skateboard assembly for providing a rider a surf-like experience, said skateboard assembly comprising a deck having a bow, an aft, and a wheelbase, an aft truck and a bow truck each comprising an axle, the trucks disposed transversely beneath the deck, wherein the distance between the aft truck and the bow trick axles define a wheelbase, wherein the axle of the aft truck has a length greater than the axle of the bow truck, and wherein the length of the wheelbase corresponds to a profile of the deck to provide analogous roll, pitch and yaw of a surfboard having an equivalent profile.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1a is a top view of a fish skateboard assembly in accordance with an embodiment of the present invention.

FIG. 1b is a bottom view of the fish skateboard assembly of FIG. 1.

FIG. 2 is a perspective view of a fish skateboard assembly in accordance with an embodiment of the present invention.

FIG. 3 is a side view of the fish skateboard assembly in accordance with an embodiment of the present invention.

FIG. 4a is a front view of the fish skateboard assembly in accordance with an embodiment of the present invention.

FIG. 4b is a back view of the fish skateboard assembly in accordance with an embodiment of the present invention.

Like reference characters designate identical or corresponding components and units throughout the several views, which are not to scale unless otherwise indicated.

### DETAILED DESCRIPTION

One embodiment of the present invention involves a skateboard assembly for providing a rider a surf-like experience, said skateboard assembly comprising a deck having a bow, an aft, and a wheelbase, an aft truck and a bow truck each comprising an axle, the trucks disposed transversely beneath the deck, wherein the distance between the aft truck and the bow trick axles define a wheelbase, wherein the axle of the aft truck has a length greater than the axle of the bow truck, and wherein the length of the wheelbase corresponds to a profile of the deck to provide analogous roll, pitch and yaw of a surfboard having an equivalent profile.

Specific configurations and arrangements of the claimed invention, discussed below with reference to the accompanying drawings, are for illustrative purposes only. Other configurations and arrangements that are within the purview of a skilled artisan can be made, used, or sold without departing from the spirit and scope of the appended claims. For example, while some embodiments of the invention are herein described with reference to skateboards, a skilled artisan will recognize that embodiments of the invention can be implemented in other settings such as roller skating and scooter riding.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features. As used herein, the term “approximately” may be defined as a given measurement varying as much as 10 percent of the total measurement in any direction. As used herein, the term “equivalent profile” may be defined as two objects having corresponding shape, but not necessarily having the same size. For example, two boards with an equivalent profile may be approximately similar, but need not be congruent.

As used herein, the axes of board shall be defined as being vertical, longitudinal and lateral. The vertical axis passes through the board from top to bottom, that is, from the top of the deck down through the wheels. The longitudinal axis passes through the board from nose to tail (which are referred to herein as “aft” and “bow”, respectively), while the lateral axis passes through the board from side to side. Furthermore, as used herein, the terms “roll”, “pitch” and “yaw’ may refer to typical Tait-Bryan angles most often associated with flight dynamics.

One embodiment of the present invention relates to a skateboard assembly for providing a rider a surf-like experience. The skateboard assembly may comprise a deck, a pair of trucks disposed transversely beneath the deck, and a pair of wheels rotatably connected to opposite ends of each pair of trucks.

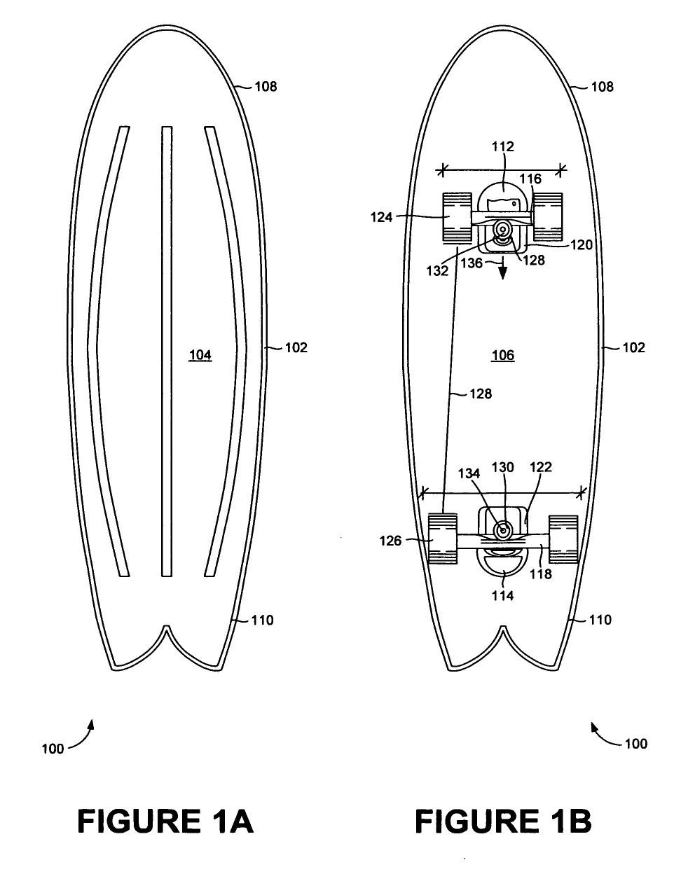

Referring now to FIGS. 1a and 1b, a skateboard assembly is shown generally at reference numeral 100. The skateboard assembly 100 may comprise a deck 102 having a top 104, a bottom 106, a bow 108 and an aft 110. The skateboard assembly may further comprise a bow truck 112 and an aft truck 114. Each truck 112 and 114 may comprise an axle 116 and 118 disposed transversely beneath the deck 102, each axle extending parallel to the lateral axis of the deck 102. In this exemplary embodiment, the trucks may attached to the deck bottom 106 in a known method, such as attaching a baseplate 120 and 122 to the deck bottom 106 via screws, and attaching the axle 116 and 118 to the baseplate 120 and 122 via bushings 128 and 130. The skateboard assembly 100 may further comprise two pair of wheels 124 and 126 which are rotatably connected to opposite ends of each axle 116 and 118. The pair wheels 124 and 126 may be mounted on each axle via ball bearings, as is known in the art.

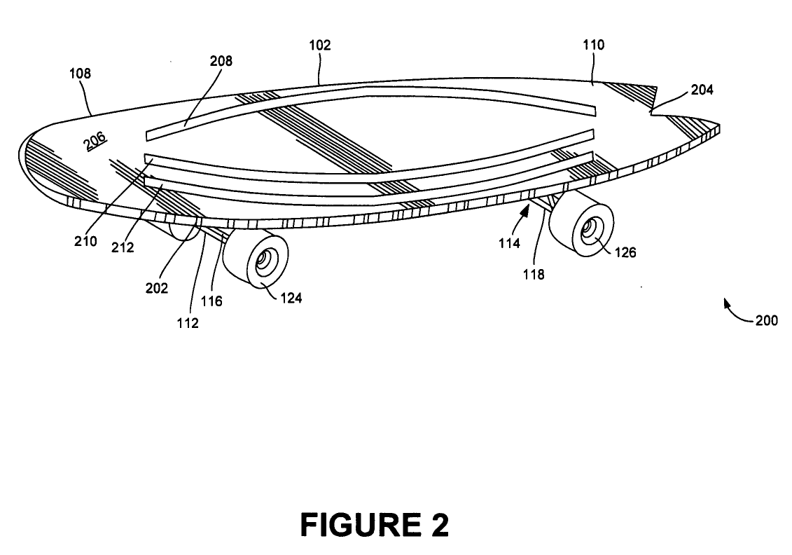

In an exemplary embodiment of the present invention, the axle 118 of the aft truck 114 has a length that is greater than the axle 116 of the bow truck 112. In this way, the rider of the skateboard assembly 100 will be provided with a surf-like experience that corresponds to the profile of the deck. By providing a bow truck axle 116 that is shorter than the aft truck axle 118, the skateboard 100 pitches in way (shown by arrow 202 in FIG. 2) that is unlike known skateboards, and, when coupled with a specific wheelbase length 128 (to be discussed in greater detail with further reference to FIG. 1) provides a ride that has analogous roll, pitch and yaw of a surfboard having an equivalent profile.

In an exemplary embodiment of the present invention, the distance between the bow truck 112 and the aft truck 114 defines a wheelbase 128. Similarly to the difference in truck axle size, the length of the wheelbase greatly influences the feel of the ride, providing varying roll, pitch and yaw. In the context of surfing, it is the difference in shape of the surfboard that provides varying roll, pitch and yaw.

In the exemplary embodiment shown in FIGS. 1a and 1b the profile of the deck comprises a “fish” profile. The length of the wheelbase 128 coupled with difference in aft and bow truck axle length gives the skateboard 100 a similar roll, pitch and yaw to a fish-shaped surfboard. As shown, the fish skateboard of FIGS. 1a and 1b, the bow truck axle 116 may be approximately 9.5 inches in length and the aft truck axle 118 may be approximately 10.5 inches in length. However, it should be noted that on a fish board of a different length or width, the truck axle lengths may increase or decrease analogously.

Still with reference to FIGS. 1a and 1b, the wheelbase 128 of a fish profile skateboard may be at least approximately 40 percent of the total length of the deck 102, and preferably approximately 45 percent of the total length of the deck 102. In the same exemplary embodiment, the length of the aft 110 is approximately 50 percent shorter than the length of the bow 108. For example, the bow 108 may be approximately 18 inches, and the aft 110 may be approximately 9.5 inches, while the wheelbase may be 21 inches, so that the total length of the deck 102 measure approximately 4 feet in length.

Referring now to FIG. 2, a perspective view of a fish skateboard assembly in accordance with an embodiment of the present invention is shown generally at 200. The skateboard assembly 200 comprises comprise a deck 102, a bow 108 and an aft 110. The skateboard assembly 200 may further comprise a bow truck 112 and an aft truck 114. Each truck 112 and 114 may comprise an axle 116 and 118 disposed transversely beneath the deck 102, the axle 116 and 118 extending parallel to the lateral axis of the deck 102. The skateboard assembly 100 may further comprise two pair of wheels 124 and 126 which are rotatably connected to opposite ends of each axle 116 and 118.

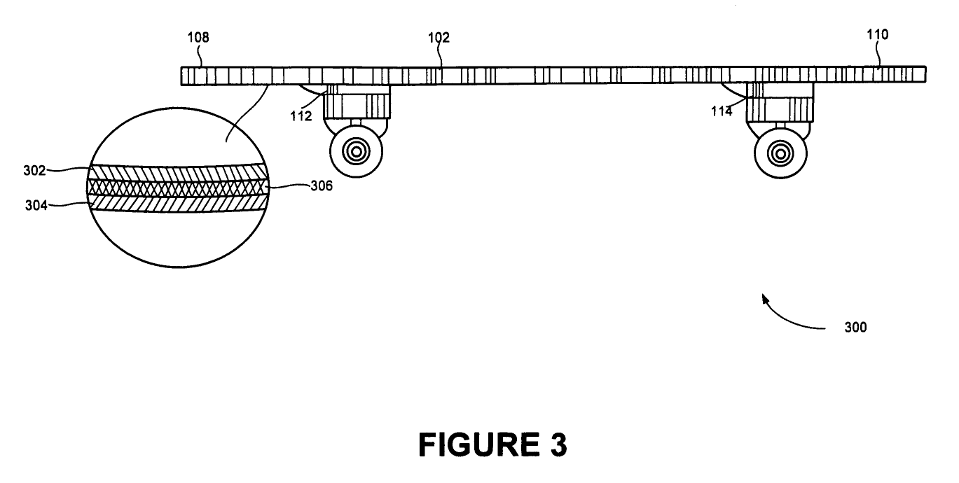

As shown, the deck 102 comprises a fish profile having a dual-tipped recessed tail 204, also known in the art as a “swallow-tail”, which mirrors the profile of fish surfboard. Referring further to the deck 102, the deck 102 may comprise a wood shell 206 surrounding a longitudinally extending aperture which extends down the longitudinal axis and through the lateral axis such that an interior space (not shown) is defined. Inlays 208-212 may be further disposed within the interior space, and may be visible on the top of the deck, as shown in FIG. 2, or optionally may be disposed within the interior aperture, which is shown with reference to FIG. 3.

With reference now to FIG. 3, a side view of a fish skateboard assembly in accordance with an embodiment of the present invention is shown generally at 300. The skateboard assembly 300 comprises comprise a deck 102, a bow 108 and an aft 110. The skateboard assembly may further comprise a bow truck 112 and an aft truck 114. It can best be seen in FIG. 3 that the bow 108 is substantially longer than the aft 110. In an optional embodiment of the resent invention, the deck 102 may comprise top 304, bottom layer 304 and an inlay 306. Each of layers 302 and 304 may comprise plywood (e.g., A or B grade) configured to sandwich the inlay 306 (shown by crosshatching) held together by sufficiently strong adhesives (e.g., glue). The inlay 306 may comprise carbon-graphite, or carbon graphite derivates. The inlay may be disposed within the interior space formed by the top and bottom plies 302 and 304 for added strength.

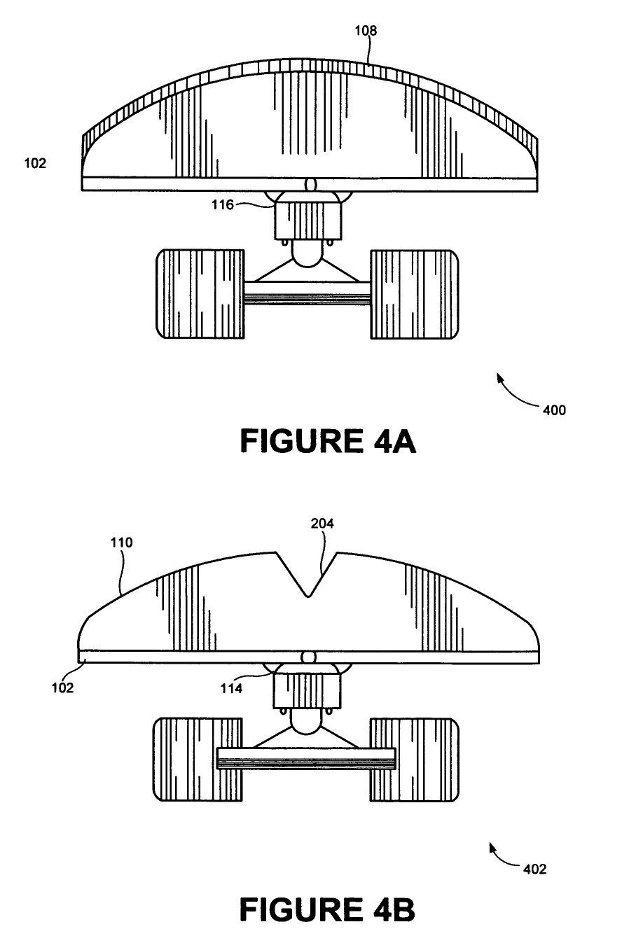

Referring now to FIGS. 4a and 4b, a front view of the fish skateboard is shown at reference numeral 400 and a back view of the fish skateboard is shown at reference numeral 402. It can best be seen from these two figures that the bow may turned upward approximately 4 degrees from the end of the wheelbase, while the aft remains on a plane equal to the wheelbase (0 degrees).

In other embodiments of the present invention, the profile of the deck may be egg or longboard. If the profile is egg, the wheelbase may be approximately 25.5 inches, the bow may be approximately 13 inches, the aft may approximately 9.5 inches, and the width may approximately 16 inches. In this way, the egg board may have a wider turn radius, which in turn provides for similar roll, pitch and yaw as a ride on an egg profiled surfboard. Similarly, if the deck has a longboard profile, the wheelbase may increase accordingly, as a longboard has an even wider turn radius than an egg profiled board. Therefore, the wheelbase may be approximately 24 inches, the aft may approximately 9.5 inches, the bow may be approximately 28 inches and the width may approximately 16 inches. In this way, the longboard provides similar roll, pitch and yaw as a ride on a longboard surfboard.

Referring back to FIG. 1b, each of the trucks 112 and 114 comprise a baseplate 120 and 122 attached to the deck 102, spacers 128 and 130 for providing cushioning. The back spacer 130 may comprise two spacers as is known in the art and also an angled spacer set at approximately 40-50 degrees. A kingpin 132 and 134 connects the baseplate 120 and 122 to the axles 116 and 118. At times, it may be preferable for a rider to adjust the ride of his or her skateboard. Therefore, the aft truck 114, bow truck 112 or both may be adjustable along the longitudinal axis of the deck 102, such as is shown by arrow 136. The adjustment may occur via a sliding mechanism having a locking pin mechanism.

It should be noted that other profiles applicable to the present invention may include a parabolic egg, a speed egg, a mini-gun, a pin-tail gun, a California gun, a nose-rider longboard and a shortboard.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

What is claimed is:

1. A skateboard assembly for providing a rider a surf-like experience, said skateboard assembly comprising:
a deck having a bow, an aft, and a wheelbase;
an aft truck and a bow truck each comprising an axle, the trucks disposed transversely beneath the deck, wherein the distance between the aft truck and the bow trick axles defines the wheelbase; and
wherein the axle of the aft truck has a length greater than the axle of the bow truck.

2. The skateboard assembly of claim 1, wherein a profile of the deck comprises longboard, egg, or fish.

3. The skateboard assembly of claim 1, wherein the aft truck has a length of approximately 10.5 inches and bow truck has a length of approximately 9.5 inches.

4. The skateboard assembly of claim 1, wherein the wheelbase has a length that corresponds to profile of the deck and is configured to provide a rider with a similar roll, pitch and yaw of a surfboard having a similar profile.

5. The skateboard assembly of claim 1, wherein the deck comprises:
a wood shell surrounding a longitudinally extending interior aperture; and
at least one inlay disposed in the interior aperture.

6. The skateboard assembly of claim 1, wherein the wood shell is formed of plywood and the inlay is carbon graphite or a derivative thereof.

7. The skateboard assembly of claim 1, wherein the wood shell comprises a top layer and bottom layer, wherein the inlay is disposed in between the layers using adhesives or rivets.

8. The skateboard assembly of claim 1, wherein if the profile of the deck is fish, the deck further comprises a swallow tail at the aft.

9. The skateboard assembly of claim 1, wherein the bow or aft truck is adjustable along the longitudinal axis of the deck.

10. A skateboard assembly for providing a rider a surf-like experience, said skateboard assembly comprising:
a deck having a bow, an aft, and a wheelbase;
an aft truck and a bow truck each comprising an axle, the trucks disposed transversely beneath the deck, wherein the distance between the aft truck and the bow trick axles defines a wheelbase;
wherein the axle of the aft truck has a length greater than the axle of the bow truck; and
wherein the length of the wheelbase is corresponds to a profile of the deck to provide analogous roll, pitch and yaw of a surfboard having an equivalent profile.

11. The skateboard assembly of claim 10, wherein at least one of the trucks is adjustable along the longitudinal axis of the deck.

12. The skateboard assembly of claim 10, wherein at least one of the trucks further comprises:
a baseplate attached to the deck;
a kingpin for connecting the baseplate to an axle having a pair of rotable wheels attached at opposite ends of the axle;
a slider having a pin and locking mechanism configured to slidably move the truck in a direction parallel to the length of the board.

13. The skateboard assembly of claim 10, wherein the profile of the deck comprises fish, parabolic egg, speed egg, mini-gun, pin-tail gun, California gun, longboard, nose-rider longboard, and shortboard.

14. The skateboard assembly of claim 10, wherein when the profile of the deck is fish, the wheelbase is approximately 21 inches, the aft is approximately 9.5 inches, the bow is approximately 18 inches, and the width is approximately 16 inches.

15. The skateboard assembly of claim 10, wherein when the profile of the deck is longboard, the wheelbase is approximately 24 inches, the aft is approximately 9.5 inches, the bow is approximately 28 inches and the width is approximately 16 inches.

16. The skateboard assembly of claim 10, wherein when the profile of the deck is egg, the wheelbase is approximately 25.5 inches, the bow is approximately 13 inches, the aft is approximately 9.5 inches, and the width is approximately 16 inches.

17. The skateboard assembly of claim 10, wherein the aft truck has a length of approximately 10.5 inches and bow truck has a length of approximately 9.5 inches.

18. The skateboard assembly of claim 10, wherein the deck comprises:
a wood shell surrounding a longitudinally extending interior aperture; and
at least one inlay disposed in the interior aperture

19. The skateboard assembly of claim 10, wherein the wood shell is formed of plywood and the inlay is carbon graphite or a derivative thereof.

20. The skateboard assembly of claim 1, wherein the wood shell comprises a top layer and bottom layer, wherein the inlay is disposed in between the layers using adhesives or rivets.
